(19) United States
(12) Patent Application Publication
(10) Pub. No.: US 2009/0177634 A1
(43) Pub. Date: Jul. 9, 2009

(54) Method and System for an Application Domain

(75) Inventors: Michael Behrendt, Randersacker (DE); Gerd Brelter, Wildberg (DE); Martin Reitz, Dettingen (DE)

Correspondence Address: INTERNATIONAL BUSINESS MACHINES CORPORATION;Richard Lau, IPLAW DEPARTMENT / Bldg 008-2, 2455 SOUTH ROAD - MS P386, POUGHKEEPSIE, NY, 12601, US

(73) Assignee: INTERNATIONAL BUSINESS MACHINE CORPORATION, Armonk, NY (US)

(21) Appl. No.: 12/350,376

(22) Filed: Jan. 8, 2009

(30) Foreign Application Priority Data
Jan. 9, 2008 (EP) 08100241.2

(51) Int. Cl. G06F 7/06; G06F 17/30

(52) U.S. Cl. 707/3; 707/E17.108

(57) ABSTRACT

Data processing comprising requesting a semantic description from each manageable resource of a plurality of manageable resources. An application domain comprises the plurality of manageable resources. The semantic description of a manageable resource comprises semantic information about a plurality of aspects of a manageable resource. The semantic information is specified by use of an ontology. The semantic descriptions and a conceptualization of the application domain is stored in a knowledge base. The conceptualization of the application domain is provided by the ontology. The conceptualization comprises semantic information about the application domain. A request from a client of the application domain to provide a manageable resource with specific properties is received. The specific properties are specified in the request. The semantic information of the conceptualization and the semantic descriptions is used for selecting the manageable resource with the specific properties from the plurality of manageable resources.

### FIELD OF THE INVENTION

The invention relates to a data processing method which uses semantic information of an ontology and semantic descriptions of a plurality of manageable resources for selecting one or more manageable resources from a plurality of manageable resources of an application domain. The data processing method is further employable for the creation of new manageable resources and aggregation of higher-level manageable resources. The invention also relates to a data processing system that is adapted to perform the method in accordance with the invention.

### BACKGROUND

The term application domain is used in the context of this document in order to refer to an application landscape management domain. An application landscape management domain can be regarded as an entity through which on-demand services of an on-demand information technology (IT) infrastructure are provided to one or more client systems that make use of these services.

On-demand services are provided by a technology called on-demand computing or utility computing, also known as cloud computing. Utility computing relates to the provision of computing resources, such as computation and storage, as a metered service to clients similar to a physical public utility such as, for example, water or natural gas. Utility computing provides the advantage of low or no initial costs to acquire hardware. Computational resources are essentially rented. Customers with very large computations or a sudden peak in demand can also avoid the delays that would result from physically acquiring and assembling a large number of computers.

Conventional Internet hosting services have the capability to quickly arrange for the rental of individual servers, for example, by providing a bank of web servers to accommodate a sudden surge in traffic to a web site.

“Utility computing” usually envisions some form of virtualization so that the amount of storage or computing power available is considerably larger than that of a single time-sharing computer. Multiple servers are used on the “back end” to make this possible. These might be a dedicated computer cluster specifically built for the purpose of being rented out or even an under-utilized supercomputer. The technique of running a single calculation on multiple computers is known as distributed computing.

The term “grid computing” is often used to describe a particular form of distributed computing, where the supporting nodes are geographically distributed or cross administrative domains. To provide utility computing services, a company can “bundle” the resources of members of the public for sale, who might be paid with a portion of the revenue from clients.

Today's IT infrastructure resources are composed of a large number of heterogeneous, distributed resources. The key to build on-demand IT infrastructure from the heterogeneous and distributed resources is to provide means for managing these resources through a common, standard based interoperability between resources.

The Web Services Resource Framework (WSRF) introduces a technology for exposing each type of resource via well-defined web service interfaces. In particular, WSRF concentrates on the stateful characteristics of IT resources, for example the CPU temperature of a computer system. The state of these WS-resources is stored in so-called resource properties. The sum of all resource properties for a specific resource is contained in the resource properties document which is an XML document. WSRF defines a WS-resource as a stateful web service that is associated with a resource properties document describing its state. It is possible to retrieve a single resource property, multiple resource properties or the entire resource properties document via standardized web service calls defined by WSRF.

The WS-ServiceGroup specification is part of WSRF that allows grouping of resources. It defines a general-purpose resource that aggregates information about multiple resources and thereby offers a new view on these resources like a directory or registry. Each resource that is a member of a WS-ServiceGroup has an entry in the resource properties document of the directory. The resource that represents the WS-ServiceGroup is operating on copies of the resource properties of the aggregated resources.

Web Services Distributed Management (WSDM) is a standard defined by OASIS on top of WSRF. WSDM consists of two parts. The first part relates to Management using Web Services (MuWS) and addresses basic mechanisms and message exchange patterns for managing WS-resources using web services as the base technology. It also defines a relationship between WS-resources as a special kind of resource property. The second part relates to Management of Web Services (MoWS) and deals with the management of web services itself that represent WS-resources. It can be viewed as both an implementation and an extension of MuWS.

The core concept of WSDM is the so-called manageable resource (MR), which is a WSRF WS-resource that offers a set of standardized capabilities defined by the WSDM MuWS standard. The manageable resource can therefore be regarded as a web service. The manageable resource has three important documents associated with it: an XML schema defining the format of the resource properties document, a WSDL document describing the web service that represents the manageable resource and the resource properties document describing the current state of the manageable resource. A so-called manageability consumer can access the manageable resource using predefined message exchange patterns that are specified as part of the WSDM MuWS capabilities definitions. The entire WSDM specification is focused on the standardization of interfaces of manageable resources. It does not target at specifying standards for the implementation details of manageable resources.

Web Services Addressing (WS-Addressing) is a specification of the web services stack. It introduces the concept of End Point Reference (EPR) in order to address specific resource instances and normalize the addressing information typically used by transport protocols and messaging systems. An EPR is an XML fragment that conveys the information that is needed to address stateless and stateful web service end points. EPRs basically address similar problems as URIs do in the HTTP-based World Wide Web.

WS-management describes a general SOAP-based protocol for managing systems like computer systems, devices, applications and other manageable entities. SOAP is a computing standard for defining how to format messages used by web services and a communication protocol. WS-management allows identifying a core set of web services specifications, usage requirements and a common set of operations that is central to system management. WS-management includes specifications for discovery and grouping of resources, setting and getting of properties, notification, and execution of specific management methods. In each of this area of scope, it defines and recommends minimal implementation requirements for conformant web services implementations.

The Resource Description Framework (RDF) is a standard for knowledge representation in the semantic web. It supports the symbolic representation of information about resources. Information is expressed in RDF statements with three parts: subject, predicate and object. Subjects, predicates and partly objects are URI references that are a special kind of URIs with optional fragment identifiers. Fragment identifiers address resources within the scope of base URIs. They are appended to URIs using a ‘#’ character as a separator. Using URI references for subject, predicate, and partly object of statements, RDF supports the use of shared vocabularies for describing resources: Terms and concepts of a vocabulary which is defined in an ontology can be used in RDF statements by referencing them via URIrefs. RDF is based on the graphical RDF graph model which defines a RDF graph as a collection of RDF statements. There are several representation formats for RDF graphs. For example, RDF/XML provides syntax to serialize RDF graphs as XML documents. It supports a predefined vocabulary that is used to render RDF graphs in XML. Another representation format is N-Triple which serializes RDF graphs by appending subject, predicate and object of an RDF statement per line, followed by a period.

RDF comes along only with a rudimentary vocabulary. The domain specific vocabulary and knowledge used to describe resources of a domain is intended to be declared somewhere outside of RDF and then referenced from the RDF statements. One aspect of such an ontology is to provide this kind of domain-specific vocabulary. An ontology provides a terminology by which resources are described and constitute context that adds semantics to their descriptions. An ontology is a data model that represents a set of concepts within a domain and the relationships between those concepts. It is used to reason about the objects within that domain. An ontology can be implemented in form of a graph structure of concepts that can be identified in a domain together with additional information that describes the concepts more in detail and how they are related to each other. For the concepts that are identified in the domain and additional information that describes the concepts more in detail, the term conceptualization of the ontology will be used in the following.

The OWL Web ontology Language, OWL, offers a vocabulary that builds upon RDF and thus provides means to model sophisticated ontologies as RDF graphs. OWL is hereby used as a recursive acronym for OWL Web ontology Language. This can be done by modeling classes, properties and instances. OWL classes are described extensionally as sets of instances that are called class extensions. Classes can be defined by using set operators like Union, Intersection and Complement. Multiple inheritance allows the modeling of class hierarchies. Classes can be further described with property restrictions. These conditions are applied on the properties of the class instances and constrain them. While primitive classes are described exclusively by necessary conditions, defined classes are described by at least one necessary and sufficient condition. The latter ones allow deriving the membership of a resource to a class based on its properties. The conditions are property restrictions which can be refined in quantifier restrictions, cardinality restrictions, and value restrictions. Properties are characteristics of resources and can be defined in OWL in a hierarchy of multiple inheritances. They have global scope meaning that they are not defined in and restricted to the scope of a specific class. There are two types of properties. Object properties link resources with other resources while data type properties link resources with literals. Property characteristics can be used to enrich the meaning of properties. For each property the domain and range as well as the inverse property can be specified. Further, it can be described as functional, inverse-functional, transitive or symmetric. Finally, instances of classes can be specified in OWL.

The SPARQL protocol and RDF query language (SPARQL) is a query language to fetch information from RDF graphs. It provides the extraction of information in form of URIs, literals or RDF sub-graphs. SPARQL is based on matching graph patterns. The matching is realized by the binding of variables that satisfy the patterns. The building blocks of queries are triple patterns with a notation similar to N-Triple. A SPARQL query is a sequence of clauses similar to the select-from-where clauses of SQL.

Manageable resources provide abstraction of and standardized access to the resources of the IT landscape managed by an application domain. Typically there exists a set of relationships among the resources of such a managed domain. Various types of relationships and dependencies between resources are a fundamental aspect of a domain-description.

WSRF and WSDM, the established technologies for defining and implementing manageable resources, operate on a syntactical level. The resource properties and relationships of a manageable resource are specified as XML elements in an XML schema document. The resource properties document describing the current state of the manageable resource is also given as an XML document. It provides access to the resource properties on a syntactical level. Resource properties are XML elements that can be accessed through the names and that contain XML fragments or literal data as values. The manageable resources operations are described in the WSDL document either on a syntactical level of input-, output-, and forward messages that are XML documents. No assertions about the semantics are made explicit except for the naming and documentation which is not accessible for machines, for example for the above mentioned manageability consumers of an application domain.

The mentioned aspects of manageable resources, namely resource properties, relationships, their value and operations, are described only syntactically. No assertions about their semantics are made. Other aspects of manageable resources like the description of manageable resources itself containing entities are not formalized at all. This results in a lack of possibilities how client systems such as the above mentioned manageability consumer can access and manipulate manageable resources. Further, applications executed on the clients have no explicit domain model available that gives a description of the manageable resources of the application domain. Applications only deal with syntactical constructs and have to implicitly assume the semantics. They access resource properties by their names and get returned XML elements as values, process literal data, construct XML documents as messages and forward them to manageable resources operations.

It is an object of the invention to describe manageable resources that expose one or more aspects in a semantic way. Such manageable resources will be further called semantically enriched manageable resources. It is further an object of the invention to describe a method and a data processing system that make use of such semantically enriched manageable resources.

### BRIEF SUMMARY

According to a first aspect of the invention, there is provided a data processing method. In accordance with an embodiment of the invention, an application domain comprises a data processing system and a plurality of manageable resources. The method in accordance with the invention is performed by the data processing system and comprises the step of requesting a semantic description from each manageable resource of the plurality of manageable resources, wherein the semantic description of a manageable resource comprises semantic information about the set of aspects of the manageable resource, and wherein the semantic information is specified by use of an ontology. In a further step of the method in accordance with the invention, the semantic descriptions of the plurality of manageable resources are stored in a knowledge base. Further, a conceptualization of the application domain is stored in the knowledge base, wherein the conceptualization of the application domain is provided by the ontology, and wherein the conceptualization comprises semantic information about the domain.

The ontology can be regarded as data model that defines the set of concepts within the application domain and the relationships between those concepts. The set of concepts along with the relationships between those concepts is referred to as conceptualization which is stored by the data processing system for further use.

In accordance with an embodiment of the invention, a semantic description is generated by a manageable resource when it is requested by a manageability consumer, e.g. the data processing system. The manageable resource employs the ontology, which provides a terminology for describing the set of aspects of the manageable resource in a semantic way. This provides the advantage that the data processing system which receives the semantic description of the manageable resource gets semantic information about the set of aspects. The data processing system therefore receives semantic information about the characterizing properties and the current state of the manageable resource and therefore becomes aware about the semantics of the manageable resource, i.e. about what manageable resource it is dealing with. This leads to an increase of the machine processability of the manageable resource that has provided the semantic description. The manageable resource might for example be programmed to make use of the ontology for the generation of the semantic information. The ontology might thus be implicitly hard-coded in the program code of the manageable resource by the programmer of the manageable resource.

In accordance with an embodiment of the invention, the manageable resources are hosted by a computer system or are distributed among a plurality of computer systems. The data processing system is linked with the computer system or the plurality of computer systems via network connections through which the semantic descriptions of each manageable resource can be requested and actually sent to the receiving data processing system.

In accordance with an embodiment of the invention, the receiving data processing system further comprises a reasoner which is also denoted as a rule engine. The data processing system stores the received semantic description of the manageable resources in the knowledge base and scans the semantic description for OWL import statements. An OWL import statement relates to an ontology, wherein each ontology relating to an import statement is further retrieved and stored in the knowledge base. Further, rules provided by the ontology are stored in the reasoner which is invoked to perform interference on and processing of the semantic information and the ontology in the knowledge base in order to “understand” and to use the manageable resources on the basis of the information provided by the semantic information.

In accordance with an embodiment of the invention, the data processing system retrieves a semantic description of the manageable resource. The manageable resource is adapted to generate the semantic description in response to the data processing system's request compliant to the terminology of the ontology. The ontology is thus known to the first manageable resource. As an alternative approach to the generation of the semantic description by the manageable resource, the data processing system retrieves semantic information about the set of aspects of the manageable resource and generates the semantic description of the manageable resource by itself. The semantic information is provided in the form of meta-data annotations in the WSDL document and the XML schema document of the resource properties document. The data processing system stores the semantic description of the manageable resource in its knowledge base.

In accordance with an embodiment of the invention, the data processing system further retrieves the ontology of the application domain and stores its conceptualization in the knowledge base together with the semantic descriptions of the manageable resources. The rules contained in the ontology are passed to the reasoner which is used to process the knowledge on a logical level based on the rules provided by the ontology. The data processing system employs the reasoner for further processing of the semantic information.

For example, the set of aspects of a manageable resource could be semantically described by meta-data comprised in the WSDL document, in the XML schema document, or in the resource properties document that are used to describe the aspects of each manageable resource as mentioned previously. The meta-data could be enriched with semantic annotations by the use of SAWSDL and additional constructs. The acronym SAWSDL stands for Semantic Annotations for WSDL and is a continuation of the WSDL-S approach. SAWSDL defines a mechanism to associate semantic annotations with the elements of WSDL documents that describe web services. Conventional WSDL documents specify the interface of web services on a syntactical level in form of input- and output-messages for the operations they offer.

SAWSDL provides semantic annotations as additional modeling constructs in form of WSDL extensions. The semantic annotations of SAWSDL are realized through references to concepts of the application domain which are defined and maintained outside of SAWSDL and represented in any suitable language like OWL or UML, which is an acronym for the Unified Modeling Language.

The semantic annotations in SAWSDL are provided by extensibility elements for WSDL. An attribute named model reference specifies the association with the concept of some semantic model through an URI. In this way, the semantic of a WSDL element can be specified by a reference to some external concept. Semantic annotations of this kind can be used to describe the set of aspects relating to manageable resources.

SAWSDL defines the WSDL extensibility elements precondition and effect that can be used to describe operations of web services and thus that can be used to describe the operations relating to the manageable resource. A precondition defines requirements or restrictions that must be fulfilled before a service operation can be invoked. An effect specifies the consequences of invoking an operation. The specification recommends to model the assertions in the domain model and to reference it via a model reference attribute. Alternatively, the attribute expression supports a way to express the assertions as string literals in any semantic representation language.

SAWSDL is a mechanism to semantically describe web services on meta-data level in the WSDL document. However, in the SAWSDL standard, it is only treated vague how the additional semantic information could be exploited in a discovery component and how reasoning could be realized is not discussed at all. According to the standard provided by SAWSDL, it is only intended to be applied to stateless web services, not to stateful web services that are represented by, e.g. a manageable resource.

In accordance with an embodiment of the invention, the meta-data provided by a manageable resource is enriched with model reference attributes and precondition elements and effect elements as intended by SAWSDL. Additionally, the URI of the underlying ontology has to be specified in the WSDL document by proper attributes. This is achieved by a model reference attribute of the enclosing WSDL XML element. The XML schema document of the resource properties document of the manageable resource is also enriched with semantic annotations of SAWSDL. In this way, the resource properties of the manageable resource are semantically described through model reference attributes in the XML schema declaration.

In accordance with an embodiment of the invention, an aspect of the set of aspects relates to the type of a manageable resource, wherein the ontology comprises a class for the type, wherein the type of the manageable resource is semantically described by use of the class.

The ontology might, for example, provide a class for each type of manageable resources comprised in the application domain. This allows then to describe the aspect of each manageable resource which relates to the type of the corresponding manageable resource via the corresponding class provided by the ontology.

In accordance with an embodiment of the invention, an aspect of the set of aspects relates to a set of resource properties of a manageable resource, wherein a resource property of the set of resource properties comprises data-by-value information, wherein the data-by-value information of the resource property is associated with a datatype property provided by the ontology, and wherein the datatype property provides semantic meaning for the data-by-value information.

In accordance with an embodiment of the invention, a resource property comprises a relationship, wherein the relationship refers to a relation of a first manageable resource with a second manageable resource that is comprised in the application domain. The relationship is associated with an object property provided by the ontology, and the object property provides semantic meaning for the relationship.

In accordance with an embodiment of the invention, an aspect of the set of aspects relates to a set of operations, wherein a manageable resource is adapted to provide the operations of the set of operations, wherein each operation of the set of operations is represented by at least one rule, and wherein the rule provides semantic meaning for the corresponding operation in form of preconditions and effects.

In accordance with an embodiment of the invention, the terminology of the ontology is specified by use of OWL.

In accordance with an embodiment of the invention, the type of a manageable resource is represented by an OWL class. The manageable resource is therefore an instance of the corresponding OWL class.

In accordance with an embodiment of the invention, each resource property of the set of resource properties which contains literal data is represented by an OWL datatype property, and a resource property which represents a relationship is represented by an OWL object property.

In accordance with an embodiment of the invention, the type of a manageable resource is described as an RDF statement, wherein the predicate is RDF:type and the object is an URIref to the resource representing the class of which the manageable resource is an instance of.

In accordance with an embodiment of the invention, a rule comprises preconditions and effects, wherein the preconditions and effects are described by triple patterns that have the same structure as RDF statements. The triple patterns contain URIrefs or variables. Variables are place holders that are bound by a reasoner in order to match the RDF statements of the queried RDF graph with the triple patterns of the rule.

In accordance with an embodiment of the invention, the set of aspects of a manageable resource is described by use of a set of RDF statements, wherein the set of RDF statements builds upon the terminology of the ontology, and wherein the terminology is provided by use of OWL. The set of RDF statements is also denoted as RDF graph. The manageable resource is therefore a stateful web service that exposes information about its current state and the discussed aspects via an RDF graph which is included into the resource properties document as an alternative or in combination with the syntactic information comprised therein.

In accordance with an embodiment of the invention, the semantic description comprises the set of RDF statements. Further, the semantic description is provided along with the resource properties document associated with a manageable resource to the data processing system. The set of RDF statements is also referred to in the following as RDF graph.

The method in accordance with one or more embodiments of the invention is therefore particularly advantageous as aspects of a manageable resource are described semantically. According to the previously mentioned embodiments of the invention, there are at least five aspects of the manageable resource that can be modeled and described semantically. First, a manageable resource as a whole represents a self-containing entity that can be semantically described. More precisely, the type of the manageable resource can be associated with a class of the ontology which provides a terminology for the application domain which comprises the corresponding manageable resource.

Further, the operations provided by the manageable resource can be described semantically. This is of interest for automated management applications that operate on manageable resources where problem solving and planning are fundamental issues. The set of manageable resource operations the management application has at disposal forms the problem solving methods, the applications latitude to act and manipulate its environment. Especially, preconditions and effects of the operations express the semantics of manageable resources operations.

Moreover, the resource properties within the resource properties document can have associated semantics. While conventional resource properties contain data-by-value, WSDM relationships can be regarded as a special kind of resource properties that contain endpoint references to other resources as data-by-reference and convey specific semantics.

The manageable resource itself can be modeled as an OWL class. The types of manageable resources that occur in a domain can be reflected in an OWL ontology by a class for each type. The resource properties of manageable resources can be modeled as OWL properties. OWL provides means for modeling both resource properties and relationships. The former ones can be modeled as OWL datatype properties that contain literal data while the latter ones can be modeled by OWL object properties that reference other resources. The values of resource properties can be modeled by a classification mechanism which is called value partitioning. Here, a set of subclasses represents the disjoint partitions of the value space. A value is classified in the way that it is instance of exactly one of the value partition subclasses.

The preconditions and effects of the manageable resource operations have to be modeled in a way that enables logical programming with the semantic description of the manageable resource. OWL itself does not provide means to model logical programming, so the manageable resource operations are modeled as rules that can be applied to a rule engine which is also denoted as reasoner. Rules comprise two parts, the so-called premises, heads or preconditions and the conclusions, bodies or effects. The building blocks for the rules are terms of triple patterns that may contain variables. By variable binding, RDF statements can be matched. The description format for the operations preconditions and effects is seamlessly integrated in the RDF as semantic description format for the manageable resource in this way.

In accordance with an embodiment of the invention, the method further comprises the step of generating a semantic description for each manageable resource of the application domain. Each semantic description comprises a set of RDF statements, wherein the set of RDF statements describes semantically the actual state and the properties of the corresponding manageable resource. The method further comprises the step of integrating each semantic description into a semantic environment description. The semantic environment description can then be provided to one or more clients of the application domain which can be used by the clients in order to find out the properties and the actual states of specific manageable resources of the application domain, or in order to get information about the relationships between manageable resources or the whole application domain.

In accordance with an embodiment of the invention, the data processing system receives a request from a client of the application domain to provide a manageable resource with specific properties, wherein the specific properties are specified in the request. According to a further step of the method in accordance with the invention, the semantic information of the conceptualization and the semantic descriptions that are stored in the knowledge base are used for selecting the manageable resource with the specific properties from the plurality of manageable resources. The method in accordance with the invention is particularly advantageous as the client must only specify in a semantic way what kind of manageable resource it wants to employ. The data processing system then selects according to the specific properties that are specified in the request and by use of the semantic information about the manageable resources and about the ontology which it has stored in the knowledge base and by use of logical reasoning, the proper manageable resource which can then be further accessed by the client.

In accordance with an embodiment of the invention, the data processing system receives a request from the client of the application domain, wherein the client requests for the provision of a particular on-demand service, wherein specifications of the particular on-demand service are provided in the request. According to a further step of the method in accordance with the invention, the semantic information of the conceptualization and of the semantic descriptions in the knowledge base are used by the data processing system to select the manageable resources that must be combined in order to be able to provide the corresponding on-demand service that is based on the selected manageable resources to the client such that the on-demand service has the requested specifications.

In accordance with an embodiment of the invention, the method in accordance with the invention further comprises the step of using the ontology and the explicit semantic descriptions of the plurality of manageable resources for inferring further implicit information of the plurality of manageable resources and/or of the application domain. The implicit information is then stored in the knowledge base and used for further processing and selecting the manageable resource in case the client requests for a manageable resource or use for selecting the one or more manageable resources that contribute to the above mentioned on-demand service. The knowledge base therefore represents a single point in the application domain where domain specific knowledge, the explicit knowledge provided by the ontology in the manageable resources and the implicit information derived from the explicit information, is stored, and where it can be logically processed and accessed by the clients that are able to make use of the semantic information. The knowledge base thus subsumes all information about the domain in one point, enables logical processing via rules, for example provided by a rule engine, and allows complex selective access to it via, e.g., SPARQL queries. Finally this knowledge base can be seen also as a single, heterogeneous registry for semantically empowered manageable resources. The information about all the manageable resources whose semantic descriptions, e.g., in form of RDF graphs, have been retrieved, are stored in it together with the meta-data that describes their semantics. Again, SPARQL provides complex selective access to the data and thus to the registered manageable resources. The semantic information can therefore be used to provide a requested manageable resource or an on-demand service that is based on the manageable resources to a requesting client.

In accordance with an embodiment of the invention, the explicit information and/or the implicit information of the plurality of manageable resources and/or of the application domain are used for the creation of a new manageable resource. The implicit information hereby relates to the semantic information of the conceptualization and the semantic description explicitly stored in the knowledgebase.

In accordance with an embodiment of the invention, the explicit information and/or implicit information of the plurality of manageable resources and/or of the application domain are used for the aggregation of two or more manageable resources to a higher-level manageable resource. The method in accordance with the invention is therefore particularly advantageous as the implicit and/or explicit information allows selecting, combining and configuring two or more manageable resources such that a higher-level manageable resource is created.

In accordance with an embodiment of the invention, the method comprises scanning for semantic descriptions of undetected manageable resources, wherein an undetected manageable resource is characterized in that its semantic description is not stored in the knowledge base. A detected semantic description of a so far undetected manageable resources is then stored in the knowledge base.

In accordance with an embodiment of the invention, a set of rules is used for logically processing the semantic descriptions and the conceptualization stored in the knowledge base, wherein the set of rules is provided by the ontology, and wherein the set of rules provides specifications how to prepare and logically process the semantic information provided by the semantic descriptions and the conceptualization.

In accordance with an embodiment of the invention, the semantic information about the set of aspects of a manageable resource comprise semantic information about an operation provided by the manageable resource, wherein the set of rules comprises at least a rule, wherein the rule reflects the preconditions required for invoking the operation of the manageable resource and the effects that the execution of the operation of the manageable resource causes to the application domain. Triple patterns can, for example, be used to model the preconditions and effects of the rule. In this way the rules can be seamlessly integrated and are applicable to the RDF graphs in the knowledge base.

In accordance with an embodiment of the invention, each manageable resource of the plurality of manageable resources is addressable by a unique identifier assigned to the manageable resource. The semantic description of each manageable resource employs a unique reference to correlate the semantic description to the corresponding manageable resource. The method in accordance with the invention further comprises the step of generating mapping information. The mapping information provides a mapping of the two kinds of unique identifiers, the EPRs and the URIs. Further, the mapping information is stored in and provided by a so called mapping service.

In accordance with an embodiment of the invention, the client requests for a manageable resource by providing a unique identifier of the manageable resource, wherein the method in accordance with the invention comprises using the mapping information and the unique identifier to determine the unique reference of the corresponding manageable resource and sending the unique reference to the client, wherein the client employs the unique reference for further interaction with the manageable resource. The mapping information is particularly advantageous as manageable resources that are typically referenced by a unique identifier can be mapped to the unique reference by which they are referenced within the semantic description, e.g., within the RDF graphs.

In accordance with an embodiment of the invention, the conceptualization and/or the set of rules are retrieved from an ontology service, wherein the conceptualization is specified by meta-data relating to the declarative knowledge about the application domain and to the semantics associated with the declarative knowledge. The ontology service, which can for example be hosted by a separate data processing system, provides the advantage that the declarative knowledge about the application domain and its associated semantics is separated from the procedural knowledge that is held on the data processing system in form of application program code. The ontology service further provides the advantage that the ontology can be formalized and explicitly provided in a single point to the application domain in form of a meta-data service. In this way it is easier to develop and maintain an ontology and make available the ontology to a management application that provides and generates an on-demand service on the basis of the manageable resources at runtime. The ontology service is thus consciously placed external to the management application. It can thus be used by other applications so that it supports interoperability and integration concerns.

In accordance with an embodiment of the invention, the meta-data relating to the declarative knowledge of the application domain is distributed among a plurality of documents, wherein the plurality of documents is held by the ontology service. The partition of the ontology among a plurality of documents is done for better reusability and due to performance aspects to arrange the ontology in small portions that are faster to process and composeable.

In accordance with an embodiment of the invention, the semantic description of each manageable resource comprises a RDF graph, wherein the RDF graph comprises a set of RDF statements, and wherein the set of RDF statements comprises the semantic information about the set of aspects of the manageable resource. As already mentioned before, the semantic description, or more precisely, the semantic information about the aspects of the manageable resource, is preferably provided by use of an RDF graph that comprises a set of RDF statements that provide semantic descriptions of the aspects of the corresponding manageable resource.

In accordance with an embodiment of the invention, the ontology comprises the conceptualization, wherein the conceptualization is specified by use of the OWL Web ontology Language (OWL). The meta-data relating to the declarative knowledge about the application domain and to the semantics associated with the declarative knowledge is specified by use of OWL, and the meta-data and the conceptualization are stored in form of RDF graphs in the knowledge base. The ontology defines the terminology in which the manageable resources are semantically described. It further formally describes the relevant concepts or aspects in the domain. Thus, the ontology provides the meta-data or context which is required for reasoning on the semantic descriptions of the manageable resources.

In accordance with an embodiment of the invention, the knowledge base is implemented in form of a database.

According to a second aspect, the invention relates to a computer program product with computer executable instructions that are adapted to perform steps of the method in accordance with the invention.

According to a third aspect of the invention, there is provided a data processing system for an application domain, wherein the data processing system comprises components that are adapted to perform steps according to the method in accordance with the invention.

According a fourth aspect of the invention, there is provided an application domain that comprises one or more components that are adapted to perform steps of the method in accordance with the invention.

### BRIEF DESCRIPTION OF THE SEVERAL VIEWS OF THE DRAWINGS

The following embodiments of the invention will be described in greater detail by way of example only with reference to the drawings in which:

FIG. 1 is a block diagram of an application domain.

FIG. 2 is a flow diagram illustrating steps performed by a method in accordance with an embodiment of the invention.

FIG. 3 is a block diagram of an embodiment of an application domain.

### DETAILED DESCRIPTION

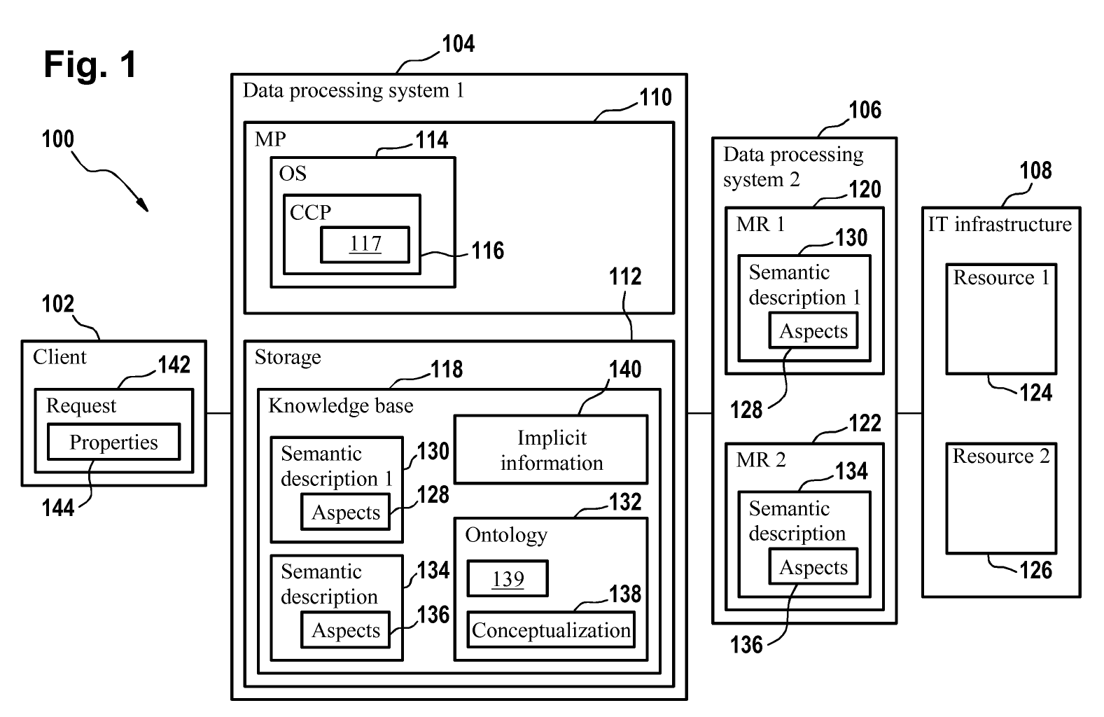

FIG. 1 is a block diagram of an application domain 100. The application domain 100 comprises a client 102, a first data processing system 104, a second data processing system 106, and an IT infrastructure 108.

The data processing system 104 comprises a microprocessor 110 and storage 112. The microprocessor 110 executes an operating system 114 that is stored permanently on the storage 112 and loaded for execution into the microprocessor 110. The operating system 114 is further used for executing a computer program product 116 that is permanently stored on the storage 112. The computer program product 116 is further adapted to maintain a knowledge base 118 on the storage 112.

The second data processing system 106 can be regarded as a computer system that hosts a first manageable resource 120 and a second manageable resource 122. The manageable resources 120 and 122 can be regarded as computer programs that are hosted by the data processing system 106. The data processing system therefore comprises a microprocessor and storage for executing the computer programs corresponding to the manageable resources and for storing them permanently on the data processing system.

The IT infrastructure 108 comprises two resources, 124 and 126. The IT infrastructure 108 can be regarded as a set of heterogeneous physical and logical IT resources. The resource 124 might, for example, relate to a computer system, whereas the resource 126 is an operating system. The manageable resources 120 and 122 expose the management interface of the resources 124 and 126, respectively, in a well defined and standardized manner, e.g., the WSRF and WSDM standards specify the protocols for interacting with the resources on a syntactical level.

Each manageable resource is associated with a set of aspects. The aspects are used to describe the current state and other properties of the corresponding manageable resource as well as its operations. The manageable resource 120 is associated with the aspects 128. One aspect of the aspects 128 relates to the type of the manageable resource 120. Other aspects of the aspects 128 are the operations that are provided by the manageable resource 120. Further aspects are the resource properties, the values of the resource properties and the relationships that can be regarded as a special kind of resource properties and that contain end point references to other resources. The manageable resource 120 is adapted to generate a semantic description 130, for example, in response to the reception of a request to generate that description which is sent by the data processing system 104. The generated semantic description of the manageable resources uses terminology defined in an ontology 132 that is according to this embodiment of the invention stored in the knowledge base 118.

The ontology 132 provides a terminology for describing aspects 128 of the manageable resource 120 in a semantic way. The semantic description 130 therefore contains semantic information about the aspects 128 which can be provided, as mentioned before in response to the data processing system 104 in case this data processing system requests for the semantic description 130.

Similarly, the manageable resource 122 generates a semantic description 134 that comprises a semantic description of aspects 136 of the manageable resource 122. The aspects 136 of the manageable resource 122 correspond to the aspects 128 of the manageable resource 120 and the semantic information about the aspects 136 is also described by use of the terminology provided by the ontology 132.

The computer program product 116 is adapted to request the first manageable resource 120 and the second manageable resource 122 to provide the semantic descriptions 130 and 134. In response to the reception of the semantic descriptions 130 and 134, the computer program product 116 stores the semantic description 130 comprising semantic information of the aspects 128 as well as the semantic description 134 comprising information about the aspects 136 in the knowledge base 118.

The ontology 132 comprises a conceptualization 138. In particular, the ontology 132 can be regarded as a formal and explicit specification of the conceptualization 138. The conceptualization 138 represents a set of resource classes, and object properties that can be identified in the application domain 100 and that are specified by the ontology 132.

The computer program product 116 is further adapted to analyze the ontology 132 and the semantic descriptions 130 and 134 for generating implicit information 140 about the domain 100. The implicit information 140 relates to semantic information that is not explicitly but implicitly given in the ontology 132 or in the semantic descriptions 130 and 134. The computer program product 116 therefore adds rules 139 defined in the ontology to a reasoner 117 which is a component of the program 116 and which is applied to the knowledge base. The reasoner 117 adds implicit information 140 explicitly to the knowledge base 118. The reasoned 117 is also denoted as rule engine.

The client 102 is adapted to send a request 142 to the data processing system 104. The client specifies in the request properties 144 of a manageable resource that should be made available to the client 102 by the data processing system 104. The properties 144 of the request manageable resource could be specified in form of semantic information. The computer program product 116 is able to analyze the properties 140 and to use the semantic information comprised in the conceptualization 138, the semantic descriptions 130 and 134 and the added implicit information 140 as stored in the knowledge base 118 in order to select the manageable resource, for example one of the manageable resources 120 or 122, that has the properties 144 or in order to modify and aggregate manageable resources to a new resource that is returned to a requesting client on-demand. This is done by reasoning according to rules to preconditions and effects. The manageable resource that is, for example, selected in accordance with the specified properties 144 is then made available to the client 102.

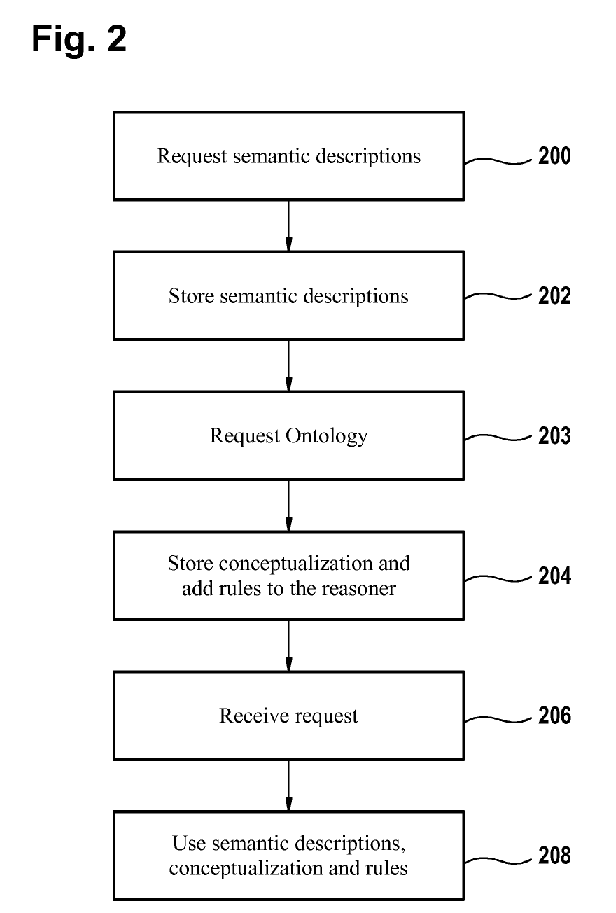

FIG. 2 shows a flow diagram illustrating steps of a method in accordance with the invention. According to step 200 of the method in accordance with the invention, a semantic description is requested from each manageable resource of a plurality of manageable resources, wherein the plurality of manageable resources is comprised in an application domain, and wherein the semantic description of a manageable resource comprises semantic information about a set of aspects of the manageable resource, wherein the semantic information is specified by use of an ontology. According to step 202, the semantic descriptions of the plurality of manageable resources are stored in a knowledge base. According to step 203, an ontology of the application domain is requested from an ontology service. Further, according to step 204, the corresponding ontology is retrieved, the contained conceptualization of the application domain is stored in the knowledge base, and the contained rules are added to the reasoner. The conceptualization of the application domain and the rules are provided by the ontology, wherein the conceptualization comprises semantic information about the domain and wherein the rules provide means to infer additional implicit information and to describe the semantics of manageable resource's operations. According to step 206, a request is received from a client of the application domain. The client thereby requests for the provision of a manageable resource with specific properties, wherein the specific properties are specified in the request. According to step 208, semantic information of the conceptualization in the semantic descriptions and reasoning based on the rules contained in the ontology are used for selecting the manageable resource with the specific properties from the plurality of manageable resources or for configuring aggregating manageable resources to higher-level manageable resources.

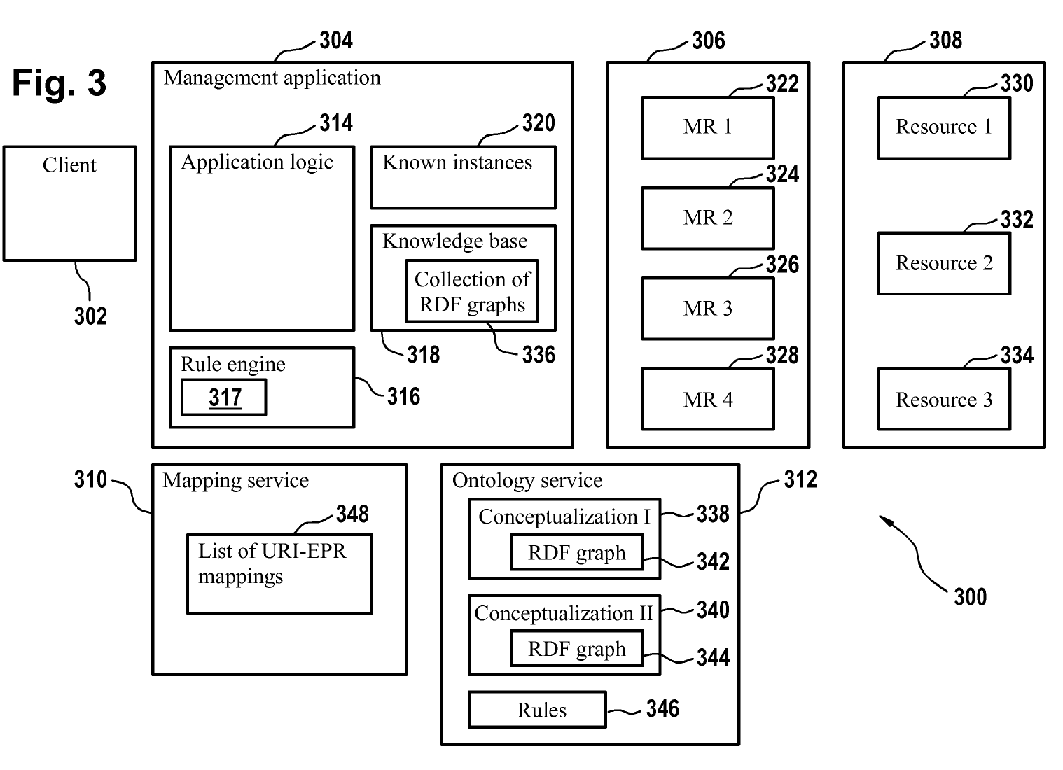

FIG. 3 shows a block diagram of an embodiment of an application domain 300. The application domain 300 comprises a client 302, a management application 304, a plurality of manageable resources 306, a plurality of ‘real’ resources 308, a mapping service 310, and an ontology service 312.

The client 302 can be regarded as a computer system that communicates with the management application 304 that can be regarded as a computer program product that is executed and hosted by a data processing system. The management application 304 comprises application logic 314 and a rule engine 316. The management application 304 further maintains a knowledge base 318 and a collection of known instances 320.

The plurality of manageable resources 306 comprises manageable resources 322, 324, 326, and 328. The plurality of resources 308 comprises resource 330, 332, and 334. The manageable resources 322-328 expose semantically enriched interfaces of the resources 330-334 as well as of their interrelations. Semantically enriched manageable resources relate to manageable resources that are adapted to provide semantic descriptions. The semantic descriptions can be provided in form of an RDF graph in an additional resource property or in form of semantic annotations in the meta-data. The semantic description exposes the current state of the corresponding manageable resource together with descriptive information in form of an RDF graph as alternative rendering of the XML based resource properties document. Like the resource properties document, the RDF graph is intended to be a transcend document rather than made persistent. The RDF graph of a manageable resource is generated at the point of time when requested by the management application 304.

The management application 304 is thus adapted to request the RDF graphs from the manageable resources and to store the received RDF graphs of the manageable resources 322-328 in the knowledge base 318. The knowledge base 318 therefore holds a collection of RDF graphs 336. Said collection comprises the RDF graphs of the manageable resources 322-328 together with the ontology's OWL conceptualization which is retrieved from the ontology service 312.

The ontology service 312 can be regarded as a computer program product that is kept on and executed by a data processing system separate to the data processing systems that host the management application 304 and the plurality of manageable resources 306. This provides the advantage that the ontology service 312 can be made available to other domains without any effect on the domain 300.

The ontology service 312 provides a library of documents that together describe the conceptualization of the application domain, such as conceptualization I 338 and conceptualization II 340 and rules 346. The conceptualizations, such as the conceptualizations I and II 338 and 340, are so called OWL documents and relate to the declarative knowledge about the application domain 300. Each conceptualization can be retrieved on-demand, for example by the management application 304. The partition of the domain's ontology into several conceptualizations is done for better reusability and due to performance aspects to arrange the ontology in small portions that are faster to process and composeable.

Conceptualizations in form of OWL documents describe the classes and properties of resources identified in the domain and the interrelationships. Because OWL is based on RDF, the OWL documents are serialized in RDF graphs like the descriptions of the manageable resources. Consequently, the conceptualization I 338 comprises an RDF graph 342, and the conceptualization II 340 comprises an RDF graph 344, wherein each of the RDF graphs 342 and 344 relates to a portion of the domains ontology that is specified in OWL and serialized in form of RDF graphs.

As mentioned before, the conceptualizations are retrieved on-demand by the management application 304. Once a conceptualization has been received by the management application 304, the RDF graphs are stored in the collection of RDF graphs of the knowledge base 318. The RDF graphs retrieved from the ontology service 312 provide in particular the vocabulary and the context for the RDF statements of the manageable resources.

The ontology service 312 further comprises the rules 346 that can also be retrieved by the management application 304. The rule engine 316 is adapted to use and apply rules 317 to the knowledge base 318, or more particularly to the RDF statements 336 comprised therein. The rules 317 relate to a subset of the rules 346 or completely contain the rules 346 as the rules 317 are loaded by the rule engine 316 from the ontology service 312. Several tasks like knowledge preparation, analysis and planning with respect to the manageable resources and with respect to on-demand services that are generated by a combination of some of the manageable resources 332-328 can be realized in this way.

The collection of RDF graphs 336 semantically describes the domain model and the current state of the domain while the rules 346 describe how the information is prepared and logically processed. The rules 346 describe, for example, the operations of manageable resources and thus reflect the acting potential of the management application 304 to manipulate the manageable resources of the domain. Each such rule reflects the preconditions that are necessary to invoke the corresponding manageable resource operation and the effects that the execution of the manageable rule operation has to the domain.

An example is the following rule:

[os1: (?x rdf:type model:ComputerSystem), (?y rdf:type
model:OperatingSystem), noValue(?x model:HasInstalled ?u),
noValue(?y model:InstalledAt ?v)
-> planning(InstallOs, ?y, ?x), (?x model:Hosts ?y)]

This rule named ‘osl’ models the semantic of an ‘install operating system’ operation of a computer system. The building blocks are terms triples which can contain variables, URI references or QNames as compact notation for URI references. The rule fires if a variable binding is found so that all terms of the precondition match with RDF triples in the knowledge base. The preconditions of this rule require a computer system, e.g. realized by one of the resources 330-334 and which has nothing installed and an operating system with license, e.g. realized by one of the resources 330-334 and which is not installed anywhere. The effect of the rule is that an operation ‘planning’ with corresponding parameters is invoked and an RDF statement is added to the collection of RDF graphs 336 of the knowledge base 318. The ‘planning’ operation is used by the planning algorithm to trace that the ‘install operating system’ operation was performed as planning step to achieve the requested goal. The RDF statement states that the computer system hosts the operating system. The knowledge base 318 then reflects the virtual situation in the domain 300 after execution of an install operating system operation, which can be origin for further planning steps until the desired situation is achieved.

Another set of rules may be used for knowledge preparation. Here, statements are added that are not given explicitly but can be inferred of existing ones. An example is the following unnamed rule that implements subclassing:
[(?x rdf:type ?a), (?a rdfs:subClassOf ?b)→(?x rdf:type ?b)]

It says: If some resource is instance of a class which is subclass of another class, then the resource is also instance of the superclass. If the rule fires, a corresponding RDF statement is added to the collection of RDF graphs 336. All assertions which can be inferred are successively added to the knowledge base in this way. The explicit assertions are analyzed in the context of the underlying ontology.

Manageable resources are addressed via EndpointReferences (EPR) as defined in the WS-Addressing specification and resources are referenced via RDF URI references (URIref) in RDF statements. Both kinds of references are necessary when combining both areas as done for the semantically empowered manageable resources 322-328 and a mapping between both reference types has to be provided. This is done by the mapping service 310 which can be regarded as a computer program product that is hosted by a data processing system, e.g., by the data processing system that executes the management application 304. The mapping service 310 provides an URIref-EPR mapping which can be realized as a Web service or a native service. It acts as a registry where all registered manageable resources store their EPR and URIref in a list of URI-EPR mappings 348.

Starting with an EPR of a manageable resource, the management application 304 can easily get the corresponding URIref by retrieving the manageable resource's RDF graph which contains its URIref. In case it wants to access a manageable resource that is only referenced in the RDF graph of another manageable resource, the mapping service 310 is required. The management application 304 can request the mapping service 310 with an URIref of a manageable resource. If the manageable resource is registered at the mapping service 310, the mapping service 310 returns the corresponding EPR. With this EPR, the management application is able to access the corresponding manageable resource via web service calls.

The management application 304 is adapted to operate in a distributed, decentralized environment of the plurality of manageable resources 306. It is even able to manage different domains and to discover the manageable resources of the IT infrastructure which it manages. Prerequisite for that is the ontology as declarative description of the domain, the mapping service 310 providing the URIref-EPR mapping and an abstraction of each managed resource 330-334 by semantically empowered manageable resources 322-328. The manageable resources 322-328 can be registered manually to the management application 304 or can be discovered automatically.

Relationships between manageable resources are reflected in OWL object properties that are part of the collection of RDF graphs 336 of already registered manageable resources. The knowledge base 318 is further searched for OWL object properties that reference to manageable resources which are unknown to the management application. Unknown hereby means that the RDF graph of the manageable resource was not loaded yet into the collection of RDF graphs 336. Awareness about known manageable resources is realized by a list of URIref-EPR pairs of the known instances 320. If the RDF graph of a manageable resource is retrieved and stored in the knowledge base 318, the pair of the manageable resource's URIref and EPR is stored in the list of known instances 320. In this way, the management application is aware of the known instances 320 and the EPRs of those manageable resources are cached in the management application 304. In this way, the management application 304 knows which manageable resources are already discovered, i.e. the semantic descriptions are retrieved and stored in the knowledge base 318 and the EPRs are stored in the list of known instances 320, i.e. the manageable resources can be accessed directly.

During discovery of manageable resources, the knowledge base 318 is searched for OWL object properties that reflect relationships between manageable resources. For each found object property, the list of known instances 320 is queried by the management application 304 whether it contains the URIref of the referenced manageable resource. If not, a relationship to an unknown manageable resource is found. In this case the management application 304 requests the mapping service 310 for the EPR that corresponds to the URIref. Then, the management application 304 accesses the manageable resource via the returned EPR. It requests the RDF graph of the manageable resource via, e.g., a ‘GetResourceProperty(RdfGraph)’ operation. The manageable resource generates the requested RDF graph at the point in time when requested by evaluating its resource properties and rendering it together with additional information in RDF/XML. Additional information hereby means aspects which are not included in the resource properties document like the classification of the entire MR or the URIref identifying the manageable resource. The RDF graph describes the current state of the manageable resource in form of an XML document that contains RDF statements about the manageable resource as semantic counterpart to the syntactical resource properties document.

The returned RDF graph is stored in the collection of RDF graphs 336 and evaluated for unsatisfied OWL import statements. OWL import statements reference to parts of the ontology that are necessary context for the RDF graph. Unsatisfied OWL import statements are processed by requesting the referenced documents from the ontology service 312. The returned OWL documents are stored in the knowledge base 318 while returned rules are added to the rule engine 316. Finally, the URIref and EPR pair of the discovered manageable resource is stored in the list of known instances 320 and the rule engine 316 is applied to the collection of RDF graphs 336 in order to prepare and logically process the stored data.

The knowledge base 318 thus represents a single point where the descriptions of all registered manageable resources are stored together with the underlying ontology that provides the context. The knowledge base 318 constitutes a single, semantics-based heterogeneous registry of the semantically empowered manageable resources 322-328. The declarative part of domain-specific knowledge is separated from the procedural part and offered as an explicit ontology and available to the management application 304 at runtime. Inference and logical programming is supported by applying the rule engine 316 with customized rules 317 to the knowledge base 318 and precise selective access to the knowledge is provided by SPARQL as query language for RDF data and an RDF API.

In the following, it is assumed that the semantically empowered manageable resources 322-328 which expose the IT infrastructure resources 330-334 are already discovered by the management application. The collection of RDF graphs 336 of the knowledge base 318 contains the RDF graphs of the manageable resources 322-328 together with the relevant parts of the underlying OWL ontology. The rule engine 316 contains the relevant rules 317 from the rules 346 of the ontology service 312 that are necessary to logically process the information in the collection of RDF graphs 336. This includes rules for knowledge preparation like classification, class hierarchies or property characteristics. Rules also describe the operations of the manageable resources and model the acting potential of the planning component.

In case the client 302 requests for the provision of a specific on-demand service, the application logic 314 invokes the rule engine 316 in order to compute a plan how the request can be satisfied through the aimed execution of rules and operations of manageable resources. The rules which are executed by the rule engine 316 are traced and filtered based on additional constraints like minimizing goals. Additional constraints could be employed for creating not only a specific on-demand service, but that one which is the cheapest or which requires the least effort to be created. The management application 304 uses the knowledge in the ontology to work out plans that satisfy the request of the client 302. The ontology provides declarative domain-specific knowledge like the structure of the requested on-demand service or the available operations.

The sum of the manageable resources' RDF graphs reflects the domain's current state. The application logic 314 executes the returned plan by execution of the operations of the manageable resources. Because the content of the knowledge base 318 is a snapshot of the domain's current state and the domain 300 has changed, a reload of the manageable resources' RDF graphs is necessary. The description of the created on-demand service can be accessed afterwards and is returned to the client 302.

The update of the knowledge base 318 can be realized through a pull- or push mechanism. In the former case, the semantically aware management application retrieves the current RDF graphs on demand. The latter case uses a publish-subscribe mechanism: The semantically aware management application subscribes for the manageable resources it currently manages and gets notifications when they change.

1. A data processing method comprising:
requesting a semantic description from each manageable resource of a plurality of manageable resources, wherein an application domain comprises said plurality of manageable resources, wherein said semantic description of a manageable resource comprises semantic information about a plurality of aspects of a manageable resource, wherein said semantic information is specified by use of an ontology;
storing said semantic descriptions in a knowledge base;
storing a conceptualization of said application domain in said knowledge base, wherein said conceptualization of said application domain is provided by said ontology, wherein said conceptualization comprises semantic information about said application domain;
receiving a request from a client of said application domain to provide a manageable resource with specific properties, wherein said specific properties are specified in said request; and
using said semantic information of said conceptualization and said semantic descriptions in said knowledge base for selecting said manageable resource with said specific properties from said plurality of manageable resources.

2. The method according to claim 1, further comprising:
using rules of said ontology added to a reasoner that is applied to said conceptualization of said ontology and said semantic descriptions of said plurality of manageable resources for determining implicit information of said plurality of manageable resources and/or of said application domain;
storing said inferred implicit information in said knowledge base; and
using said implicit information for further processing, including selecting a specific manageable resource or configuring and aggregating manageable resources to higher-level manageable resources.

3. The method according to claim 2, further comprising:
creating said manageable resource by using information selected from the group consisting of said explicit information, said implicit information of said plurality of manageable resources and of said application domain, and a combination thereof; and
aggregating two or more manageable resources to a higher-level manageable resource by using information selected from the group consisting of said explicit information, said implicit information of said plurality of manageable resources and of said application domain, and a combination thereof.

4. The method according to claim 1, further comprising:
successively discovering manageable resources of an application domain;
scanning said knowledge base for URIrefs of undetected manageable resources, wherein a semantic description of an undetected manageable resource is not stored in said knowledge base; and
retrieving and storing a semantic description of such a detected manageable resource in said knowledge base.

5. The method according to claim 1, further comprising using a plurality of rules for logically processing said semantic descriptions and said conceptualization stored in said knowledge base, wherein said plurality of rules is provided by said ontology, wherein said plurality of rules provides specifications how to prepare and logically process said semantic information provided by said semantic descriptions and said conceptualization.

6. The method according to claim 5, wherein said semantic information about said plurality of aspects of a manageable resource comprises semantic information about an operation provided by said manageable resource, wherein said plurality of rules comprises at least a rule, wherein said rule reflects the preconditions required for invoking the operation of said manageable resource and the effects that the execution of the operation of said manageable resource causes to said application domain.

7. The method according to claim 1, wherein each manageable resource of said plurality of manageable resources is addressable by use of an EPR assigned to said manageable resource, wherein said semantic description of each manageable resource employs a URIref to correlate said semantic description to the corresponding manageable resource, the method further comprising:
generating mapping information by mapping said EPR of each manageable resource to said URIref of the corresponding semantic description;
storing said mapping information; and
providing said mapping information as mapping service.

8. The method according to claim 7, wherein said client requests for a manageable resource by providing a URIref of said manageable resource, wherein the method comprises:
using said mapping information and said URIref to determine said EPR of the corresponding manageable resource; and
sending said EPR to said client, wherein said client employs said EPR for further interaction with said manageable resource.

9. The method according to claim 5, wherein said conceptualization and/or said plurality of rules are retrieved from an ontology service, wherein said conceptualization relates to meta-data relating to a declarative knowledge about said application domain and to semantics associated with said declarative knowledge.

10. The method according to claim 9, wherein said conceptualization relating to said declarative knowledge of said application domain is distributed among a plurality of documents, wherein said plurality of documents is held by said ontology service.

11. The method according to claim 1, wherein said semantic description of each manageable resource comprises an RDF (Resource Description Framework) graph, wherein said RDF graph comprises a plurality of RDF statements, and wherein said plurality of RDF statements comprises said semantic information about said plurality of aspects of a manageable resource.

12. The method according to claim 11, wherein said conceptualization of said ontology is serialized in OWL Web ontology Language (OWL), wherein meta-data relating to a declarative knowledge about said application domain and to said semantics associated with said declarative knowledge is serialized by use of OWL, wherein said conceptualization is represented in the form of an RDF graph in said knowledge base.

13. A computer program product comprising computer executable instructions, said instructions for performing the method comprising:
requesting a semantic description from each manageable resource of a plurality of manageable resources, wherein an application domain comprises said plurality of manageable resources, wherein said semantic description of a manageable resource comprises semantic information about a plurality of aspects of a manageable resource, wherein said semantic information is specified by use of an ontology;
storing said semantic descriptions in a knowledge base;
storing a conceptualization of said application domain in said knowledge base, wherein said conceptualization of said application domain is provided by said ontology, wherein said conceptualization comprises semantic information about said application domain;
receiving a request from a client of said application domain to provide a manageable resource with specific properties, wherein said specific properties are specified in said request; and
using said semantic information of said conceptualization and said semantic descriptions in said knowledge base for selecting said manageable resource with said specific properties from said plurality of manageable resources.

14. A data processing system for an application domain comprising:
means for requesting a semantic description from each manageable resource of a plurality of manageable resources of said application domain, wherein said semantic description of a manageable resource comprises semantic information about a plurality of aspects of said manageable resource, wherein said semantic information is specified by use of an ontology;
means for storing said semantic descriptions in a knowledge base;
means for requesting a conceptualization and rules from said ontology service;
means for storing said conceptualization of said application domain in said knowledge base, wherein said conceptualization of said application domain is provided by said ontology;
means for adding said rules to a rule engine and applying said rule engine to said knowledge base for inferring further implicit information, processing data in said knowledge base, and planning;
means for receiving a request from a client of said application domain to provide a manageable resource with specific properties, wherein said specific properties are specified in said request; and
means for using said semantic information of said conceptualization and said semantic descriptions in said knowledge base for selecting said manageable resource with said specific properties from said plurality of manageable resources.

15. The data processing system according to claim 14, further comprising:
means for using said conceptualization and said semantic descriptions of said plurality of manageable resources together with said rules of said ontology and a rule engine for determining implicit information of said plurality of manageable resources and/or of said application domain;
means for storing said inferred implicit information in said knowledge base; and
means for using said implicit information for further processing including selecting a specific manageable resource or configuration and aggregation of manageable resources to higher-level manageable resources.

16. The data processing system according to claim 15, further comprising:
means for creating a manageable resource from information selected from the group consisting of said explicit information, said implicit information of said plurality of manageable resources and of said application domain, said conceptualization and said rules of said ontology, and a combination thereof; and
means for aggregating two or more manageable resources to a higher-level manageable resource from information selected from the group consisting of said explicit information, said implicit information of said plurality of manageable resources and of said application domain, said conceptualization and said rules of said ontology, and a combination thereof.

17. The data processing system according to claim 14, further comprising:
means for scanning for semantic descriptions of new manageable resources, wherein a new manageable resource is characterized in that its semantic description is not stored in said knowledge base;
means for retrieving an EPR of a detected manageable resource and storing it in the list of known instances;
means for retrieving semantic description of a detected manageable resource and storing it in said knowledge base; and
means for using a set of rules for logically processing said semantic descriptions and said conceptualization stored in said knowledge base, wherein said plurality of rules is provided by said ontology, wherein said plurality of rules provides specifications how to prepare and logically process said semantic information provided by said semantic descriptions and said conceptualization.

18. The data processing system according to any one of the preceding claims 14, wherein each manageable resource of said plurality of manageable resources is addressable by use of an EPR assigned to a manageable resource, wherein said semantic description of each manageable resource employs an URIref in said semantic description to describe said manageable resource, wherein the data processing system further comprises:
means for generating mapping information by mapping said EPR of each manageable resource to said URIref of the corresponding semantic description;
means for storing said mapping information; and
means for providing said mapping information in form of a mapping service.

19. An application domain comprising:
a plurality of manageable resources;
means for storing an ontology for said application domain;
means for requesting a semantic description from each manageable resource of said plurality of manageable resources, wherein said semantic description of a manageable resource comprises semantic information about a plurality of aspects of said manageable resource, wherein said semantic information is specified by use of an ontology;
means for storing said semantic descriptions in a knowledge base;
means for storing a conceptualization of said application domain in said knowledge base, wherein said conceptualization of said application domain is provided by said ontology;
means for receiving a request from a client of said application domain to provide a manageable resource with specific properties, wherein said specific properties are specified in said request;
means for using said semantic information of said conceptualization and said semantic descriptions in said knowledge base for selecting said manageable resource with said specific properties from said plurality of manageable resources; and
means for using said semantic information about said manageable resources and said conceptualization and rules of said ontology for planning actions to aggregate higher-level manageable resources, wherein said rules are added to a rule engine (117) which is applied to said knowledge base.

20. An application domain according to claim 19 further comprising:
a means for execution of a previously determined plan to manipulate and aggregate manageable resources to higher-level manageable resources that are requested by a client.
